(19) United States
(12) Patent Application Publication
(10) Pub. No.: US 2020/0275686 A1
(43) Pub. Date: Sep. 3, 2020

(54) FOOD COMPOSITION FOR THE PREPARATION OF PRODUCTS FOR SUBJECTS WITH SWALLOWING DIFFICULTY AND USE THEREOF IN AUTOMATED DISPENSING MACHINES

(71) Applicant: HEALTHY AGING RESEARCH GROUP SRL in sigla H.A.R.G. Srl, Brescia (IT)

(72) Inventors: Matteo Luigi OPPI, Piadena CR (IT); Andrea OPPI, Piadena CR (IT); Beatrice OPPI, Piadena CR (IT)

(21) Appl. No.: 16/645,651

(22) PCT Filed: Sep. 20, 2018
(86) PCT No.: PCT/IB2018/057238

§ 371 Date: Mar. 9, 2020

(30) Foreign Application Priority Data
Sep. 20, 2017 (IT) 102017000105325

(51) Int. Cl. A23L 33/00; A23L 33/21; A23L 29/269; A23L 29/25; A23L 29/256; A23L 29/238; A23L 29/00

(52) U.S. Cl. CPC A23L 33/40; A23L 33/21; A23L 29/273; A23L 29/015; A23L 29/256; A23L 29/238; A23L 29/25

(57) ABSTRACT

Subject-matter of the present invention is a food composition suitable for the preparation of products essentially intended for the hydration of subjects with swallowing difficulty. Further subject-matter of the invention is the use of said composition in automated dispensing machines and the use of said products for the hydration of subjects with swallowing difficulty.

### SUMMARY OF THE INVENTION

Subject-matter of the present invention is a food composition suitable for the preparation of products essentially intended for the hydration of subjects with swallowing difficulty. Further subject-matter of the invention is the use of said composition in automated dispensing machines and the use of said products for the hydration of subjects with swallowing difficulty.

### TECHNICAL FIELD

Dysphagia affecting several subjects is a dysfunction correlated to swallowing; the dysphagic subject cannot swallow in a proper way mainly, but non only, liquids. Almost 50% of the elderly population is suffering from dysphagia but this disorder also occurs in patients suffering from neurologic diseases such as for example Alzheimer, stroke, Parkinson and neurodegenerative diseases. Dysphagia can lead to serious consequences, such as dehydration and malnutrition of the affected patient, as well as to involve the risk of aspirating liquids into the lungs with the resulting possible ab ingestis pneumonia.

For the nutrition, in particular for the hydration, of dysphagic subjects thickened and/or gelled aqueous products are available, which can be swallowed easier than water or other liquid foods. Such products can be available in the form of ready-to-drink beverages, or soluble compositions to be mixed with water, manually or by means of the use of automated dispensing machines. Such products can have different textures and be optionally flavored.

The use of automated dispensing machines is a particularly suitable and convenient solution for hospitals and in rehabilitation and geriatric institutes. However, the products dispensed by the automated machines have some drawbacks. Such products are prepared starting from powders comprising different components, said powders being mixed with water, usually hot, within the automated machines. As a matter of fact, it often happens that the quality of the dispensed products is not always uniform and the texture and contents of the products vary from one delivery to the other. Moreover, particles of components not perfectly dissolved in the product are often found, this fact may lead to even serious effects to the dysphagic subject.

There is therefore the need of providing compositions suitable for the preparation of products to safely hydrate and satisfy one's thirst for the subjects suffering from swallowing difficulty.

### OBJECTS OF THE INVENTION

It is an object of the invention to provide a powdered food composition to be used in combination with automated dispensing machines, in particular for hot beverages.

It is another object of the invention to provide a food composition for the preparation of products essentially, but not only, intended for the hydration of subjects with swallowing difficulty.

It is a further object of the invention to provide a thickened aqueous food product and the use thereof for the hydration of subjects with swallowing difficulty.

### DESCRIPTION OF THE INVENTION

It is a subject-matter of the present invention the use of a powdered food composition comprising saccharides and/or polysaccharides, thickening agents and optionally anticaking agents, characterized in that at least 50% of said powder has a particle size between 1 mm and 0.250 mm, for the preparation of a food product in automated dispensing machines for hot beverages.

It is a further subject-matter of the present invention a powdered food composition comprising saccharides and/or polysaccharides, thickening agents and optionally anticaking agents, to be used in combination with automated dispensing machines for hot beverages, characterized in that at least 50% of said powder has a particle size between 1 mm and 0.250 mm and characterized in that it does not contain starches. According to a preferred embodiment, in the composition of the invention 60-70% of said powder has a particle size between 1 mm and 0.250 mm.

According to a preferred embodiment, at least 65%, advantageously at least 70%, of said powder has a particle size between 0.500 mm and 0.125 mm.

According to a preferred embodiment, in the composition of the invention 70-75% of said powder has a particle size between 0,500 mm and 0,125 mm.

According to a preferred embodiment, about 60-65% of said powder has a particle size between 0.500 mm and 0.250 mm.

According to a particularly preferred embodiment, in the composition of the invention 60-70% of said powder has a particle size between 1 mm and 0.250 mm and 70-75% of said powder has a particle size between 0.500 mm and 0.125 mm. According to a particularly preferred embodiment, in the composition of the invention 60-70% of said powder has a particle size between 1 mm and 0.250 mm and 60-65% of said powder has a particle size between 0.500 mm and 0.250 mm. According to a preferred embodiment, less than 30%, advantageously less than 27% of said powder has a particle size smaller than 0.250 mm.

According to a preferred embodiment, at least 60% of said powder has a particle size between 1 mm and 0.250 mm and less than 30% of said powder has a particle size smaller than 0.250 mm.

According to a particularly preferred embodiment, in the composition of the invention
60-70% of said powder has a particle size between 1 mm and 0.250 mm,
70-75% of said powder has a particle size between 0.500 mm and 0.125 mm, and
less than 30%, advantageously less than 27% of said powder has a particle size smaller than 0.250 mm.

According to a particularly preferred embodiment, in the composition of the invention
60-70% of said powder has a particle size between 1 mm and 0.250 mm,
70-75% of said powder has a particle size between 0.500 mm and 0.125 mm, and
60-65% of said powder has a particle size between 0.500 mm and 0.250 mm.

The above reported percentages being expressed by weight, relative to the total weight of the composition.

The measurement of the particle size has been carried out by means of a granulometric analysis by sieving according to the UNI EN 933-1 standard; EC1 (Sieves (S-297), (S-298), (S-299), (S-301), (S-302), (S-322), (S-324), (S-325), (S-328), (S-329), (S-331); Oven (S-166).

According to the present invention, with “powdered food composition” it is meant herein a mixture of food solid powders (herein also defined “components”), said powder having the particle size characteristics defined above.

The expression “saccharides and polysaccharides” means herein simple sugars and complex sugars. According to the present invention, a preferred saccharide is selected from saccharose and fructose and a preferred polysaccharide are the maltodextrins.

Even if the starches could be used in the compositions for the use according to the invention, preferably the compositions do not contain any kind of starch.

The “thickening agents” include colloids, hydrocolloids, gums, jellies and thickening polymers.

The “anticaking agents” include silicon dioxide, gluconates and silicates.

All the components of the composition of the invention are selected from substances suitable for food use.

According to a preferred embodiment, the composition of the invention having the characteristic particle sizes defined above, comprises
a saccharide, preferably saccharose or fructose;
a polysaccharide, preferably a maltodextrin;
a food hydrocolloid, preferably a carrageenan;
a food gum, preferably tara gum; and
optionally silicon dioxide.

According to a preferred embodiment, the composition of the invention having the characteristic particle sizes defined above, comprises
fructose;
a maltodextrin, preferably a maltodextrin with Dextrose equivalent (DE) equal to about 6;
a carrageenan;
tara gum; and
silicon dioxide.

According to a particularly advantageous embodiment, the composition of the invention having the characteristic particle sizes defined above comprises
40-60%, preferably 55-59% of fructose, preferably of crystalline fructose;
15-25%, preferably 18-23% of a maltodextrin, preferably of a maltodextrin with a Dextrose equivalent (DE) equal to about 6;
10-20%, preferably 12-17% of a carrageenan;
5-10%, preferably 6-8% of tara gum; and
0.1-1%, preferably 0.2-0.4% of silicon dioxide;
   said percentages being expressed by weight relative to the total weight of the composition.

A particularly advantageous composition comprises
about 57% of fructose, preferably of crystalline fructose;
about 21% of a maltodextrin, preferably of a maltodextrin with a Dextrose equivalent (DE) equal to about 6;
about 14% of a carrageenan;
about 7% of tara gum; and
about 0.35% of silicon dioxide;
   said percentages being expressed by weight relative to the total weight of the composition.

In addition to the above listed components, the composition of the invention can comprise small amounts of flavors, colorants (e.g. at an amount of 1-2%) and other substances such as for example citric acid, and the like. Therefore thickened products having different flavors can be prepared starting from neutral or flavored compositions, e.g. fruity ones such as orange, berry, lemon, peach etc. Preferably, such flavors and the optional colorants are of natural origin.

It is also possible to add to the composition small amounts of other ingredients, e.g. vitamins and mineral salts, useful for the organism.

The components of the particularly advantageous compositions mentioned above comprise components known in the art and commercially available. Said components are a composition particularly suitable to the use to which it is intended according to the invention.

In particular, crystalline fructose has a high hygroscopicity and its tendency to absorb water from the surrounding environment makes it ideal to reduce the development of molds in the products wherein it is contained, thus improving their preservation. Maltodextrins are made of glucose molecules ordered into chains of different length and are classified based on the D-glucose units linked into chains. The shortest are the chains the greater will be the DE (Dextrose equivalent); to digestive purposes, the maltodextrins with a shorter chain show a behavior more similar to glucose. Preferred maltodextrins of the invention are the 6 DE maltodextrins because they have suitable thickening properties and are easily assimilated. Maltodextrins are in addition adapted for the diet of patients requiring an increase of the energy requirement, a characteristic that is often common to patients suffering from dysphagia.

Carrageenan is a natural hydrocolloid obtained by boiling read red algae of the Rodoficee class being on the stony shore of the North Atlantic. It is mainly made of calcium, potassium, sodium and magnesium salts of sulphate esters of polysaccharides. The carrageenan is used in the food industry as a thickener since it forms reversible gels and it is cold dispersible and fully soluble at 70° C. The carrageenan hot dissolves in water and solidifies by cooling.

Tara gum is a natural hydrocolloid obtained from the ground endosperm of Caesalpinia spinosa seeds, a plant of the Leguminosae family. The tara gum, also known with the name of Peruvian carob, is a white-yellowish powder soluble in hot water and partially soluble in cold water. From the chemical point of view, tara gum is made of polysaccharides, mainly galactomannans, with high molecular weight. The tara seeds flour has been classified by the European Union as a food additive and is used in the food industry mainly for its thickening and stabilizing properties. It is of simple use, has a good solubility in hot water and is partially soluble in cold water, it increases the viscosity of the products to which it is added, has a good stability during thermal treatment at high temperature and can be used with a lower dosage with respect to other hydrocolloids. The tara is also considered a stabilizer since it confers to the food a greater chemico-physical preservation over time, it avoids the decomposition of the physical substances the food is made of and favors the conservation of the creaminess. It confers a significant viscosity and avoids the product to lose its compactness and provides a gelling effect.

Silicon dioxide is a known anticaking agent and reduces the tendency of the single particles, present in a food product, to adhere each other. Even used in small amounts, the silicon dioxide avoids the formation of clots in the powdered composition.

As mentioned, the composition of the invention is particularly suitable for the use in combination with an automated dispensing machine for hot beverages. In practice, a certain amount of the composition is charged into a reservoir within the machine, e.g. few kilograms. Following suitable commands, the powder is taken from the reservoir, generally by precipitation, mixed with a hot liquid, advantageously water at 90-95° C., and stirred to favor the dissolution of the components. The resulting hot mixture is dispensed, as single dose or anyway in the desired amounts, and after cooling (e.g. in the refrigerator or in the blast chiller) a thickened aqueous food product is obtained.

With “thickened” it is meant herein a jellied water-based product, commercially defined also as “aquagel”.

It has been surprisingly discovered that the particular particle distribution of the composition of the invention allows the particle segregation to be avoided, thus providing constantly uniform and homogeneous component content to the dispensed product. In addition, the dispensed product is free from clots and solid particles.

As a matter of fact, it has been observed that the composition of the invention as defined above has optimal flowing properties in the dispensing machine, it does not form a cake even under hot and humid conditions, and maintains an optimal solubility degree. In particular, it has been observed that the flowing and the solubility of the composition of the invention are much better than the compositions known in the art, as demonstrated in the following Experimental Section.

Therefore the composition of the invention is particularly suitable for the preparation of products for the hydration of subjects with swallowing difficulty who, as mentioned, require to take thickened liquids for their hydration.

With “subjects with swallowing difficulty” it is meant herein any subject having swallowing problems, also comprising the subjects suffering from dysphagia. Such subjects are preferably mammals, advantageously human beings.

Moreover, it has been noticed that the composition of the invention, in particular the preferred compositions, e.g. the compositions of Examples 1 and 2 reported below, can be diluted in various ways to dose the density of the final product, thus allowing to adjust it for the intended subject. By way of example, it is possible to dose 50 to 80 g of the composition of the following Example 2, per liter of liquid, preferably water, and thus to obtain products with different textures. The concentration of the composition can be automatically adjusted by the machine or can be selected by the user.

As mentioned, due to its specific particle distribution, the composition of the invention is particularly suitable for the use in automated dispensing machines. However, if desired or necessary, the composition of the invention can also be transformed into the manually thickened product, by mixing with a hot liquid, preferably water at 90-95° C. and following cooling.

According to a preferred embodiment, the raw materials used in the composition of the invention are completely of natural origin and are selected and processed in order to guarantee to obtain a composition and a final thickened product with the lowest possible bacterial growth, above all considering that said product is intended to a sensitive population, i.e. elderly and/or sick.

The use of the composition of the invention for the preparation of food products for the hydration of subjects with swallowing difficulty is a further subject-matter of the invention.

Further subject-matter of the invention is a thickened aqueous food product prepared starting from a composition of the invention and the use thereof for the hydration of subjects with swallowing difficulty.

A method to hydrate a subject with swallowing difficulty is another subject-matter of the invention, comprising administering to said subject an effective dose of the thickened aqueous food product of the invention.

Studies carried out at a nursing home proved that not only the hydration of the treated subjects was significantly improved after consumption of the product of the Example 2 for a period of time, but also that the use of said product allowed the administration of laxatives for the intestinal regularization of said subjects to be limited.

The invention will be described in more detail in the following Experimental Section, by way of example only and without limitation.

### EXPERIMENTAL SECTION

### Example 1

A composition having the characteristic particle sizes reported above is prepared by mixing the following powders:
40-60% of fructose, preferably of crystalline fructose;
15-25% of a maltodextrin, preferably of a maltodextrin with a Dextrose equivalent (DE) equal to about 6;
10-20% of a carrageenan;
5-10% of tara gum; and
0.1-1% of silicon dioxide;
   said percentages being expressed by weight relative to the total weight of the composition, together with small amounts of flavors, colorants (e.g. at an amount of 1-2%).

### Example 2

A composition is prepared by mixing the following powders:
57.09% of fructose, preferably of crystalline fructose;
21.28% of a maltodextrin, preferably of a maltodextrin with a Dextrose Equivalent (DE) equal to about 6;
14.18% of a carrageenan;
7.09% of tara gum; and
0.35% of silicon dioxide;
   said percentages being expressed by weight relative to the total weight of the composition, together with 1% of flavors, colorants and citric acid.

With the granulometric analysis carried out as reported in the description of the invention on 43 g of composition, the composition of Example 2 showed the particle distribution reported in Table 1:

TABLE 1

| SIEVES | Retained | Retained | Passing |
|---|---|---|---|
| (mm) | (g) | (%) | (%) |
| 125 | 0 | 0.0 | 100.0 |
| 90 | 0 | 0.0 | 100.0 |
| 63 | 0 | 0.0 | 100.0 |
| 50 | 0 | 0.0 | 100.0 |
| 45 | 0 | 0.0 | 100.0 |
| 40 | 0 | 0.0 | 100.0 |
| 31.5 | 0 | 0.0 | 100.0 |
| 25 | 0 | 0.0 | 100.0 |
| 22.5 | 0 | 0.0 | 100.0 |
| 20 | 0 | 0.0 | 100.0 |
| 16 | 0 | 0.0 | 100.0 |
| 14 | 0 | 0.0 | 100.0 |
| 12.5 | 0 | 0.0 | 100.0 |
| 11.2 | 0 | 0.0 | 100.0 |
| 10 | 0 | 0.0 | 100.0 |
| 8 | 0 | 0.0 | 100.0 |
| 6.3 | 0 | 0.0 | 100.0 |
| 5.6 | 0 | 0.0 | 100.0 |
| 4 | 0 | 0.0 | 100.0 |
| 2 | 0 | 0.0 | 100.0 |
| 1 | 0 | 0.6 | 99.4 |
| 0.500 | 18 | 41.4 | 57.9 |
| 0.250 | 9 | 21.5 | 36.4 |
| 0.125 | 4 | 9.4 | 27.0 |
| 0.063 | 6 | 13.7 | 13.3 |
| <0.063 | 6 | 13.3 | — |

Total weight of the sample (g): 43

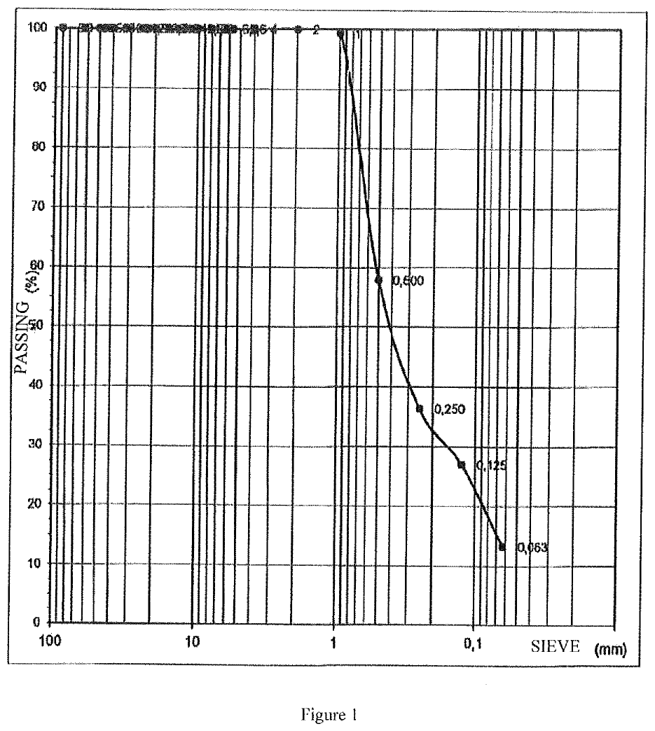

The particle distribution curve relating to the powder of Example 2 is shown in FIG. 1. As it can be noticed, the 63.5% of the product of Example 2 has a particle size between 1 and 0.25 mm.

The use of the composition of Example 2 in automated dispensing machines for hot beverages allowed a thickened aqueous product with constantly uniform characteristics for all the deliveries performed to be obtained.

### Comparative Example A

A composition for the preparation of commercially available thickened aqueous products underwent a test in dispensing machines.

With the granulometric analysis carried out as reported in the description of the invention on 51 g of composition, the composition showed the particle distribution reported in Table 2:

TABLE 2

| SIEVES | Retained | Retained | Passing |
|---|---|---|---|
| (mm) | (g) | (%) | (%) |
| 125 | 0 | 0.0 | 100.0 |
| 90 | 0 | 0.0 | 100.0 |
| 63 | 0 | 0.0 | 100.0 |
| 50 | 0 | 0.0 | 100.0 |
| 45 | 0 | 0.0 | 100.0 |
| 40 | 0 | 0.0 | 100.0 |
| 31.5 | 0 | 0.0 | 100.0 |
| 25 | 0 | 0.0 | 100.0 |
| 22.5 | 0 | 0.0 | 100.0 |
| 20 | 0 | 0.0 | 100.0 |
| 16 | 0 | 0.0 | 100.0 |
| 14 | 0 | 0.0 | 100.0 |
| 12.5 | 0 | 0.0 | 100.0 |
| 11.2 | 0 | 0.0 | 100.0 |
| 10 | 0 | 0.0 | 100.0 |
| 8 | 0 | 0.0 | 100.0 |
| 6.3 | 0 | 0.0 | 100.0 |
| 5.6 | 0 | 0.0 | 100.0 |
| 4 | 0 | 0.0 | 100.0 |
| 2 | 0 | 0.0 | 100.0 |
| 1 | 0 | 0.0 | 100.0 |
| 0.500 | 4 | 7.2 | 92.8 |
| 0.250 | 9 | 17.8 | 75.0 |
| 0.125 | 15 | 28.6 | 46.4 |
| 0.063 | 15 | 29.2 | 17.3 |
| <0.063 | 9 | 17.3 | — |

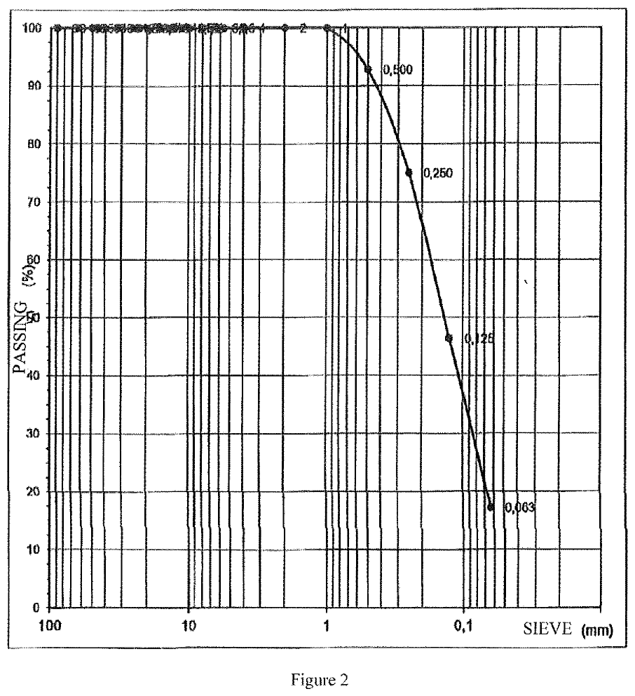

The particle distribution curve relating to the powder of the comparative Example is shown in FIG. 2. As it can be noticed, only 25% of the product on the market tested as comparative Example has a particle size between 1 and 0.25 mm, while most of the product has a smaller size.

The use of said comparative composition in automated dispensing machines for hot beverages showed the following main drawbacks:
formation of a cake of the composition under temperature conditions higher than 30° C. and high humidity in the air (e.g. in the summer period or after repeated deliveries of the product and/or heavy use of the machine, which is often used also for the delivery of other soluble products);
segregation of the particles of the product into the containers and in the main packages of the powder (which must be shaken before use in order to avoid having an already stratified product);
inhomogeneity of the dispensed product, due to the segregation of the particles in the powder mixture.

On the contrary, the higher granulometry of the compositions of the invention allowed to have a more flowing product in the dispensing machine and that much less forms cake under conditions of higher temperature/humidity, maintaining at the same time a high solubility degree.

### Example 3

Evaluation of the Hydration of Subjects with Swallowing Deficit by Means of Gelled Water in Guests of a Nursing Home

In the following the clinical trial carried out with the composition of Example 2 is summarized.

### Population

### Inclusion Criteria

Patients have been asked to join the test based on the following inclusion criteria:
Age ≥65 years hold if in RSA
Age not relevant if in RSD
Stable clinical conditions
RMI between 18 and 25
Informed consent

### Exclusion Criteria

Patients have been excluded from the selection if the following criteria have been noticed:
Active cancer disease
Kidney disease
Severe dementia (Cognitive Performance Scale >4 or other scale used by the Organization)
Pacemaker
Presence of big metal plates (e.g. osteosynthesis)

### Outcome Measurement:

1: T0 (survey start) evaluation of the hydration index by means of Bioimpedance vector
2: T1 (survey end) evaluation of the hydration index by means of Bioimpedance vector analysis and performance index of hydration on the target patient.

Measurements have been carried out by nutritionists.

### Evaluation

The hydration level has been evaluated based on the following criteria
Bioimpedance Vector
Blood tests:
electrolytes (sodium, potassium, calcium, magnesium, and phosphorous)
hydration/nutrition condition (blood count, VES, ferritin, serum albumins, azotemia, glyeemia, serum creatinine)
Urine test
Urine collection 24 h (if present)
Hydration evaluation form.

### CONCLUSIONS

The use of the product of Example 2 allowed improvements in the conditions in terms of hydration and intestinal regularization in the subjects who underwent the test to be highlighted.

1-16. (canceled)

17. A method for the preparation of a food product in automated dispensing machines for hot beverages which comprises dispensing a powdered food composition comprising saccharides and/or polysaccharides, thickening agents and optionally anticaking agents, wherein at least 50% of said powder has a particle size between 1 mm and 0.250 mm.

18. A powdered food composition comprising saccharides and/or polysaccharides, thickening agents and optionally anticaking agents, to be used in combination with automated dispensing machines for hot beverages, wherein at least 50% of said powder has a particle size between 1 mm and 0.250 mm and wherein it does not contain starches.

19. The composition according to claim 17, wherein at least 65% of said powder has a particle size between 0.500 mm and 0.125 mm.

20. The composition according to claim 19, wherein less than 30% of said powder has a particle size smaller than 0.250 mm.

21. The composition according to claim 18, wherein
60-70% of said powder has a particle size between 1 mm and 0.250 mm,
70-75% of said powder has a particle size between 0.500 mm and 0.125 mm, and
60-65% of said powder has a particle size between 0.500 mm and 0.250 mm.

22. The composition according to claim 18, wherein it comprises a saccharide; a polysaccharide; a food hydrocolloid; a food gum; and optionally silicon dioxide.

23. The composition according to claim 18, wherein it comprises fructose, a maltodextrin, a carrageenan, tara gum and silicon dioxide.

24. The composition according to claim 23, comprising
40-60% of fructose;
15-25% of a maltodextrin;
10-20% of a carrageenan;
5-10% of tara gum; and
0.1-1% of silicon dioxide;
said percentages being expressed by weight relative to the total weight of the composition.

25. The composition according to claim 23, comprising
about 57% of fructose;
about 21% of a maltodextrin;
about 14% of a carrageenan;
about 7% of tara gum; and
about 0.35% of silicon dioxide;
said percentages being expressed by weight relative to the total weight of the composition.

26. A method to hydrate a subject with swallowing difficulty is another subject-matter of the invention, comprising administering to said subject an effective dose of the thickened aqueous food product of the composition of claim 18.

27. The method of claim 26, wherein the composition reconstituted with a hot liquid in automated dispensing machines is administered to said subjects.

28. The method of claim 26 wherein said liquid is water.

29. The method of claim 17, for the hydration of subjects with swallowing difficulty.

30. The method of claim 17, wherein said food composition is a powdered food composition comprising saccharides and/or polysaccharides, thickening agents and optionally anticaking agents, to be used in combination with automated dispensing machines for hot beverages, characterized in that at least 50% of said powder has a particle size between 1 mm and 0.250 mm and characterized in that it does not contain starches.

31. The method of claim 33 for the hydration of subjects with swallowing difficulty.

32. The method of claim 30, wherein in said food at least 65% of said powder has a particle size between 0.500 mm and 0.125 mm.

33. The method of claim 30, wherein in said food
60-70% of said powder has a particle size between 1 mm and 0.250 mm,
70-75% of said powder has a particle size between 0.500 mm and 0.125 mm, and
60-65% of said powder has a particle size between 0.500 mm and 0.250 mm.

34. The method of claim 30, wherein said food comprises a saccharide; a polysaccharide; a food hydrocolloid; a food gum; and optionally silicon dioxide.

35. The method of claim 30, wherein it comprises fructose, a maltodextrin, a carrageenan, tara gum and silicon dioxide.
